(19) United States
(12) Patent Application Publication
(10) Pub. No.: US 2025/0048961 A1
(43) Pub. Date: Feb. 13, 2025

(54) RECIPROCATING SCISSORS

(71) Applicant: Milwaukee Electric Tool Corporation, Brookfield, WI (US)

(72) Inventors: Nicholas Dobernig, Brookfield, WI (US); Beth E. Cholst, Wauwatosa, WI (US)

(21) Appl. No.: 18/794,251

(22) Filed: Aug. 5, 2024

Related U.S. Application Data
(60) Provisional application No. 63/598,687, filed on Nov. 14, 2023.
(60) Provisional application No. 63/518,209, filed on Aug. 8, 2023.

(51) Int. Cl. A01D 34/685; A01D 34/73; A01D 34/84; A01D 101/00

(52) U.S. Cl. CPC A01D 34/685; A01D 34/733; A01D 34/84; A01D 2101/00

(57) ABSTRACT

A reciprocating power tool comprising a first blade and a second blade, wherein the first blade is driven by a first shaft assembly, wherein the second blade is driven by a second shaft assembly, wherein the first and second blade assemblies are reciprocally driven by a cam shaft, wherein the first shaft assembly defines a first moment of inertia, wherein the second shaft assembly defines a second moment of inertia, and wherein the first and second moments of inertia are within 5% of one another.

### CROSS-REFERENCE TO RELATED APPLICATIONS

The present application claims priority to U.S. Provisional Patent Application 63/598,687 filed on Nov. 14, 2023 and U.S. Provisional Patent Application 63/518,209 filed on Aug. 8, 2023, the disclosures of which are incorporated by reference herein in their entireties.

### FIELD

The present disclosure relates generally to outdoor power equipment, and more particularly to reciprocating scissors.

### BACKGROUND

Landscaping and yard maintenance was traditionally performed by hand using non-powered hand tools. Over time, advances were made to introduce powered hand tools, such as powered lawnmowers, powered edgers, powered string trimmers, powered dethatchers, powered blowers, and the like. The use of powered hand tools greatly reduced the time and effort required to maintain landscaping. Advances in powered hand tools have resulted in more efficient power tools which provide an enhanced user experience.

Reciprocating powered tools are used for trimming, edging, and clipping. Reciprocating power tools generally utilize multiple blades moving relative to one another. Each movement may be referred to as a stroke. Each of the blades includes a plurality of teeth. The teeth are spaced apart from each other by gaps. As the blades move relative to one another, material is introduced into the gaps between the blades and subsequently cut by the teeth. At the end of the stroke, the blades then move in the opposite direction and cut further material introduced into gaps which were previously occupied by the teeth. This process is repeated several times per minute, upwards of 3000 times per minute.

The high speed operation of the reciprocating power tool creates imbalance, resulting in vibrational loads being transmitted to the user. Over prolonged use, these vibrational loads can become uncomfortable, resulting in the user not finishing a landscaping operation.

Accordingly, improved reciprocating power tools are desired in the art. In particular, reciprocating scissors which provide smoother handling and reduced vibration would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a reciprocating power tool is provided. The reciprocating power tool includes a cam shaft rotatably driven by a motor, wherein the cam shaft comprises a first cam lobe and a second cam lobe, wherein the cam shaft defines a central axis, and wherein the first cam lobe and the second cam lobe are rotationally offset from one another about the central axis of the cam shaft; an inner shaft assembly comprising: a first link operably coupled to the first cam lobe, wherein the first link comprises a first engagement interface; a first shaft coupled to the first engagement interface and reciprocatively driven by the first link; and a first blade having an outer circumference defined by a first plurality of cutting teeth, wherein the first blade is coupled to the first shaft; and an outer shaft assembly comprising: a second link operably coupled to the second cam lobe, wherein the second link comprises a second engagement interface; a second shaft coupled to the second engagement interface and reciprocally driven by the second link; and a second blade having an outer circumference defined by a second plurality of cutting teeth, wherein the second blade is coupled to the second shaft, wherein the first link, the second link, the first shaft, and the second shaft each define a center of mass, and wherein the centers of mass of the first link, the second link, the first shaft, and the second shaft all lie within 1 centimeter (cm) of a center of mass axis.

In accordance with another embodiment, a reciprocating power tool is provided. The reciprocating power tool includes a first blade and a second blade, wherein the first blade is driven by a first shaft assembly, wherein the second blade is driven by a second shaft assembly, wherein the first and second blade assemblies are reciprocally driven by a cam shaft, wherein the first shaft assembly defines a first moment of inertia, wherein the second shaft assembly defines a second moment of inertia, and wherein the first and second moments of inertia are within 5% of one another.

In accordance with another embodiment, a reciprocating power tool is provided. The reciprocating power tool includes a first blade; a second blade coaxially aligned with the first blade; and a skid plate releasably coupled to one of the first or second blades, wherein the skid plate is selected from a plurality of skid plates each defining a different height.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a reciprocating power tool in accordance with embodiments of the present disclosure;

FIG. 2 is an enlarged view of a portion of the reciprocating power tool in accordance with embodiments of the present disclosure;

FIG. 3 is a cross section of the portion of the reciprocating power tool in accordance with embodiments of the present disclosure as seen along Line A-A in FIG. 2;

FIG. 4 is a top view of the portion of the reciprocating power tool in accordance with embodiments of the present disclosure as seen with a cover of a housing removed;

FIG. 5 is a perspective view of a link associated with the reciprocating power tool in accordance with embodiments of the present disclosure;

FIG. 6 is a perspective view of a link associated with the reciprocating power tool in accordance with embodiments of the present disclosure;

FIG. 7 is a shaft associated with the reciprocating power tool in accordance with embodiments of the present disclosure;

FIG. 8 is a shaft associated with the reciprocating power tool in accordance with embodiments of the present disclosure;

FIG. 9 is a side view of a portion of the reciprocating power tool in accordance with embodiments of the present disclosure including a first skid plate;

FIG. 10 is a side view of a portion of the reciprocating power tool in accordance with embodiments of the present disclosure including a second skid plate;

FIG. 11 is a cross-sectional perspective view of a portion of the reciprocating power tool in accordance with embodiments of the present disclosure as seen along Line B-B in FIG. 2;

FIG. 12 is a top view of a blade of the reciprocating power tool in accordance with embodiments of the present disclosure;

FIG. 13 is a side view of an edger in accordance with embodiments of the present disclosure;

FIG. 14 is a schematic, cross-sectional view of a portion of the reciprocating power tool in accordance with embodiments of the present disclosure;

FIG. 15 is a top view of a reciprocating blade set of the reciprocating power tool in accordance with embodiments of the present disclosure as seen in a first position;

FIG. 16 is a top view of the reciprocating blade set of the reciprocating power tool in accordance with embodiments of the present disclosure as seen in a second position;

FIG. 17 is a top view of the reciprocating blade set of the reciprocating power tool in accordance with embodiments of the present disclosure as seen in a third position; and

FIG. 18 is a top view of the reciprocating blade set of the reciprocating power tool in accordance with embodiments of the present disclosure as seen in a fourth position.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, reciprocating power tools described herein drive reciprocating blades to cut material. The blades include two blades reciprocally driven by first and second coaxially extending shaft assemblies. The shaft assemblies are driven by a camshaft operably coupled to a drive shaft extending from a motor. The components of the first and second shaft assemblies have similar masses, moments of inertia, and heights of centers of gravity. Moreover, the first and second shaft assemblies include components with centers of mass all disposed along a straight line corresponding with a rotational axis of those components. The reciprocating power tool can transmit less vibration and harshness to a user, allowing for a better user experience.

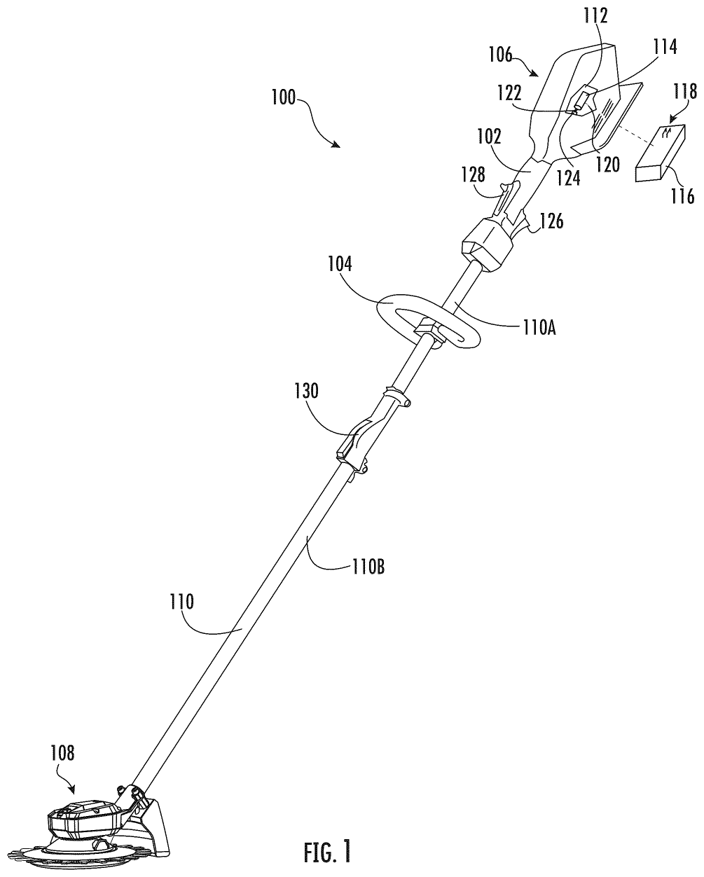

Referring now to the drawings, FIG. 1 illustrates a reciprocating power tool 100 in accordance with an exemplary embodiment. The reciprocating power tool 100 can be used for trimming, edging, clipping, cutting and many other types of landscaping maintenance and yardwork. The reciprocating power tool 100 is lightweight and handheld, including one or more user engageable areas, such as a first handle 102 and a second handle 104, to hold and maneuver the reciprocating power tool 100 over a work area. In some instances, the reciprocating power tool 100 can be used with a harness (not illustrated), such as a single shoulder strap or a double shoulder strap, to assist operators working long hours or those unable to easily support and maneuver the weight of the reciprocating power tool 100.

The reciprocating power tool 100 generally includes a housing 106, a work head 108, and a shaft 110 extending between the housing 106 and the work head 108. The first handle 102 can be at least partially defined by the housing 106. The second handle 104 can be spaced apart from the first handle 102 and disposed on the shaft 110.

The housing 106 defines an interior 112 in which a motor 114 is disposed. The motor 114 is shown schematically in FIG. 1 and is not required to be oriented, sized, or arranged as depicted. The motor 114 can be a direct current (DC) electric motor, such as a brushless DC electric motor. The motor 114 can receive power from an energy source, such as a removable battery 116, an integrated battery (not illustrated), a cable connected to an external power outlet, or from another power source. In some instances, the energy source can include a plurality of energy sources, such as two removable batteries 116. Only one removable battery 116 is depicted in FIG. 1, however it should be understood that certain embodiments of the reciprocating power tool 100 may utilize dual battery configurations to increase power at the work head 108 and to increase operating lifespan between charges.

The battery 116 can include a battery terminal 118 that interfaces with a housing terminal (not illustrated) to electrically couple the battery 116 to the motor 114. A power transfer system, such as a power cable or harness 120, can extend from the housing terminal to the motor 114 to provide electrical power to the motor 114 when the battery 116 is coupled to the housing 106.

Using power provided by the battery 116, an output shaft 122 of the motor 114 can selectively drive a distal end of a drive shaft 124 when an operator engages a trigger 126, e.g., disposed at the first handle 102. In some instances, the trigger 126 can have variable input sensitivity, allowing the operator to control the speed of the motor 114 by adjusting a relative position of the trigger 126. As the operator pushes the trigger 126, the speed of the motor 114 increases, resulting in a faster rotating drive shaft 124. Conversely, as the operator releases the trigger 126, the speed of the motor 114 decreases, resulting in a slower rotating drive shaft 124. A safety switch 128 can also be used to prevent the motor 114 from accidently driving the drive shaft 124.

The drive shaft 124 extends from the housing 106, through the shaft 110, and interfaces with the work head 108 to drive one or more blades as described in greater detail below. In an embodiment, the relative position of the housing 106 and work head 108 may be adjustable to permit customized positioning and to accommodate different users and work head 108 functionality. For example, the shaft 110 can have an adjustable length allowing the housing 106 and work head 108 to be moved together or apart. The housing 106 and work head 108 may also, or alternatively, be rotationally adjustable relative to one another to allow for different angular orientations of the work head 108. For instance, sometimes the work head 108 may be used in a horizontal orientation while other times the work head 108 may be used in a vertical orientation. The user may want to maintain the positioning of the housing 106 to allow for easy grasping and usability. To accommodate these and other adjustments, the shaft 110 can include an adjustment element 130 that locks and unlocks segments 110A and 110B of the shaft 110 relative to one another to allow the segments 110A and 110B to slide or rotate relative to one another. Once the shaft 110 is at a desired length or orientation, the adjustment element 130 can be locked to prevent further changes. The drive shaft 124 can similarly include an adjustable interface to permit adjustments to the shaft 110. By way of non-limiting example, the drive shaft 124 can include a plurality of telescoping segments rotationally pinned together, e.g., by a splined interface. The telescoping segments can rotate together through the pinned interface and also telescopically slide relative to one another to permit adjustments to the shaft 110.

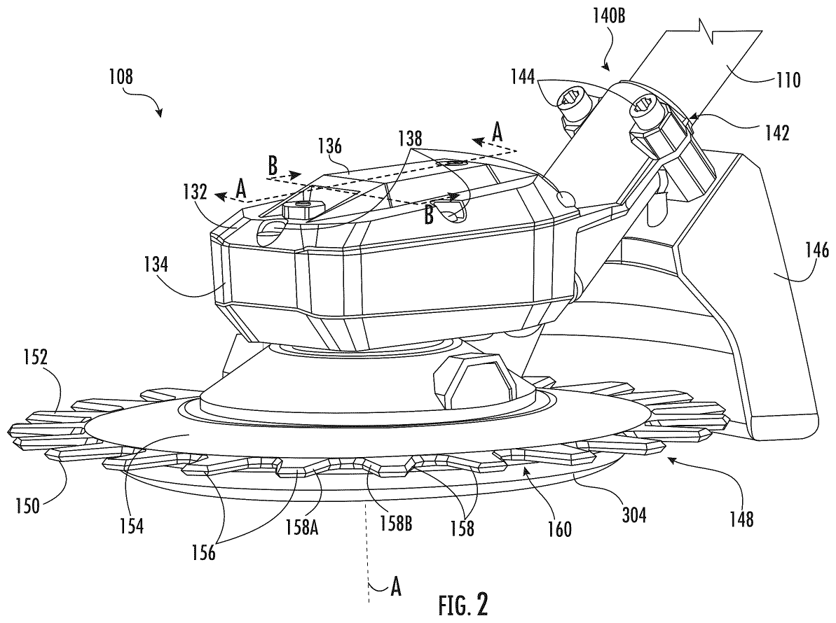

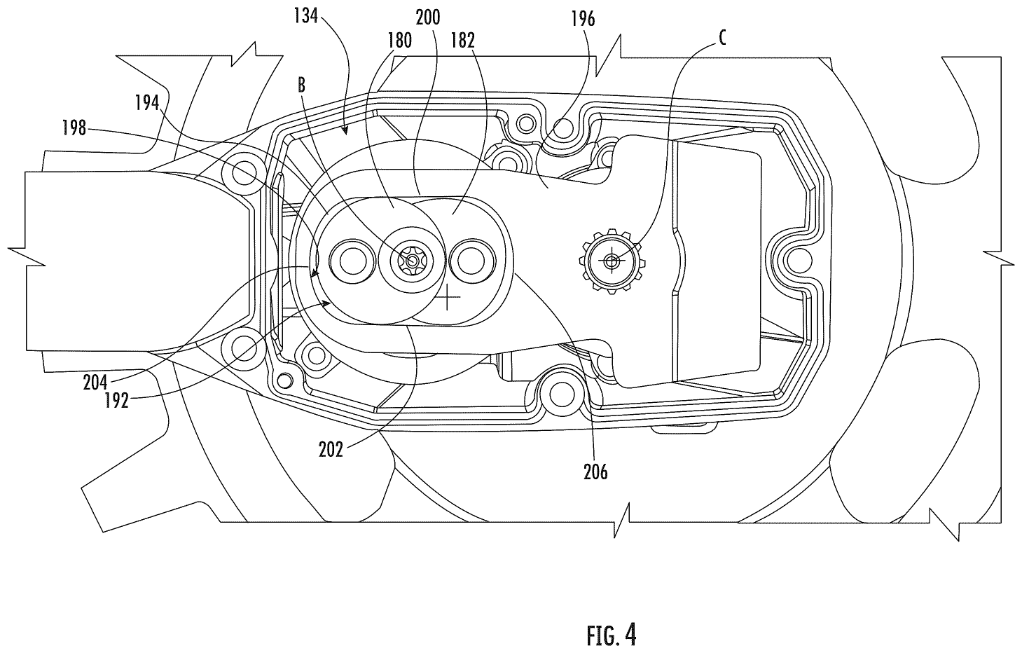

FIG. 2 illustrates a close-up view of the work head 108 in accordance with an exemplary embodiment. The work head 108 can include a housing 132 defining an internal volume 134 (FIG. 4). The housing 132 can be formed from a plurality of discrete, separate components, such as a base 134 and a cover 136 removably coupled to the base 134. By way of non-limiting example, the base 134 and cover 136 can be selectively coupled together by one or more fasteners 138, such as bolts, snaps, retaining rings, or the like.

The shaft 110 defines a proximal end 140 coupled to the housing 132. In some instances, the housing 132 can define an opening 142 into which the shaft 110 extends. Once the shaft 110 is properly positioned within the opening 142, one or more fasteners 144 are tightened to compress the opening 142 and form an interference fit between the housing 132 and the shaft 110, thereby securing the shaft 110 to the work head 108. By way of other examples, the shaft 110 can be secured within the opening 142 by an adhesive disposed between the shaft 110 and a sidewall of the opening 142, a threaded interface between the shaft 110 and the sidewall of the opening 142, a threaded or non-threaded fastener extending through the shaft 110 and the housing 132, or by using any other suitable method or device.

In an embodiment, a blade guard 146 extends from one or both of the shaft 110 or housing 132. In the depicted embodiment, the blade guard 146 is coupled to the housing 132 using the one or more fasteners 144 as described above. The blade guard 146 protects the operator against flying debris and from accidentally touching a reciprocating blade set 148 during operation of the reciprocating power tool 100.

The reciprocating blade set 148 generally includes a plurality of blades, such as a first blade 150 and a second blade 152. The first and second blades 150 and 152 reciprocate relative to one another during operation of the reciprocating power tool 100 as described in greater detail below.

The first and second blades 150 each include a central hub 154 that rotates about a rotational axis A. A plurality of teeth 156 extend radially outward from the central hub 154 of each of the first and second blades 150 and 152. Each of the plurality of teeth 156 includes at least one cutting edge 158 defined along a lateral aspect of the tooth 156. In an embodiment, each of the plurality of teeth 156 can include a plurality of cutting edges 158, such as a first cutting edge 158A defined along a first lateral aspect of the tooth 156 and a second cutting edge 158B defined along a second lateral aspect of the tooth 156 opposite the first lateral aspect. A circumferential gap 160 is defined between adjacent teeth 156 of each of the first and second blades 150 and 152. The gaps 160 of the first and second blades 150 and 152 can together define an effective gap which changes in size as the reciprocating blade set 148 reciprocates. In some instances, all effective gaps of the reciprocating blade set 148 can always share the same size as one another. In other instances, the reciprocating blade set 148 can simultaneously include effective gaps with different sizes. For instance, the teeth 156 can have widths, as measured in a circumferential direction about axis A, that are less than circumferential widths of the gaps 160, as measured in the circumferential direction about axis A. As a result, as one effective gap decreases in size, a neighboring effective gap increases in size, and vise versa. For simplicity, the following description is made with respect to an embodiment where the effective gaps of the reciprocating blade set 148 are all the same as one another, i.e., the teeth 158 and gaps 160 all share a common size, however, it should be understood that other operating schemas are included herein.

When the first and second blades 150 and 152 are oriented at a first relative rotational position with respect to one another, the gaps 160 of the first and second blades 150 and 152 are aligned with one another such that the effective gap size of the reciprocating blade set 148 is equal to a gap size of each of the first and second blades 150 and 152. When the first and second blades 150 and 152 are oriented at a second relative rotational position with respect to one another, the gaps 160 of the first and second blades 150 and 152 are misaligned with one another such that the effective gap size of the reciprocating blade set 148 is zero. When the reciprocating blade set 148 is at the first relative rotational position, material, such as grass, branches, leaves, and the like can enter the effective gaps of the reciprocating blade set 148. As the reciprocating blade set 148 moves from the first relative rotational position to the second relative rotational position, the effective gap size decreases. As a result, any material contained within the effective gap becomes compressed between cutting edges 158 of converging teeth 156, i.e., a tooth 156 of the first blade 150 and a tooth 156 of the second blade 152. As the reciprocating blade set 148 reaches the second relative rotational position, any material previously contained in the effective gap is cut by the converging teeth 156 of the first and second blades 150 and 152.

In some instances, the first and second blades 150 and 152 can continue to rotate relative to one another past the second relative rotational position. This may introduce effective gaps between different teeth 156 of the first and second blades 150 and 152. At some terminal relative rotational position, the first and second blades 150 and 152 begin to rotate in an opposite direction relative to one another. The process described above is repeated, this time in reverse, and material contained within the effective gaps is cut by converging teeth 156 of the first and second blades 150 and 152. Each rotational displacement of the first and second blades 150 and 152 can be referred to as a stroke. At full operating speed, the reciprocating power tool 100 can perform at least 500 strokes per minute (SPM), such as at least 750 SPM, such as at least 1000 SPM, such as at least 1250 SPM, such as at least 1500 SPM, such as at least 1750 SPM, such as at least 2000 SPM, such as at least 2250 SPM, such as at least 2500 SPM, such as at least 2750 SPM.

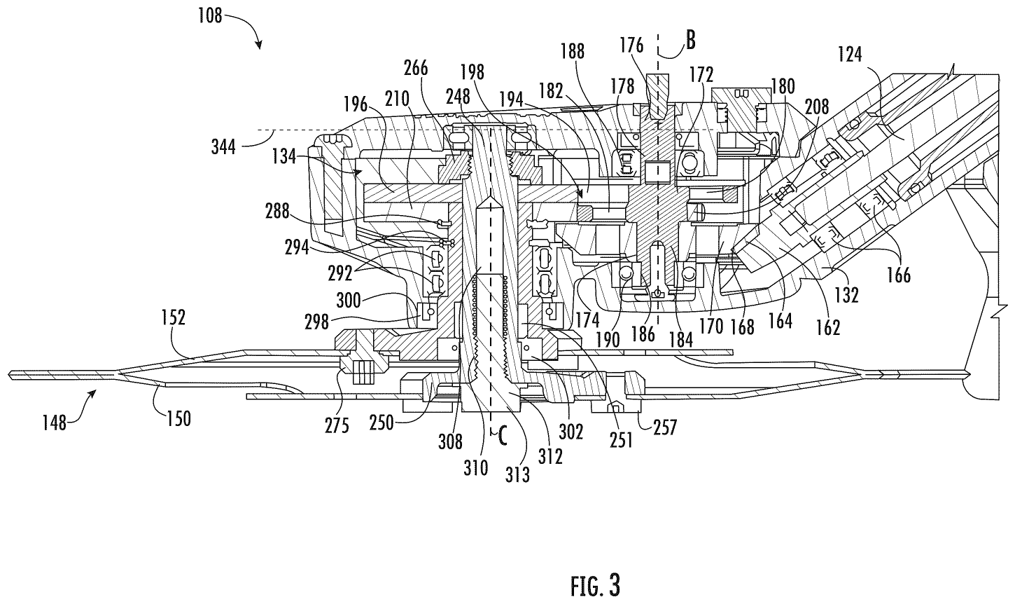

FIG. 3 illustrates a cross-sectional side view of the work head 108 as seen along Line A-A in FIG. 2. As shown, the drive shaft 124 enters the housing 132 of the work head 108. The drive shaft 124 is coupled to a bevel pinion 162 defining a toothed surface 164. The bevel pinion 162 is supported relative to the housing 132 by one or more bearings 166, such as ball bearings, needle bearings, or the like. Torque from the motor 114 (FIG. 1) is transmitted through the drive shaft 124 to rotate the bevel pinion 162. The toothed surface 164 of the bevel pinion is meshed with a complementary toothed surface 168 of a bevel gear 170. Motor torque is transmitted from the bevel pinion 162 to drive the bevel gear 170 about a rotational axis B.

The bevel gear 170 is coupled to a cam shaft 172. For instance, the bevel gear 170 can define a central aperture 174 through which the cam shaft 172 at least partially extends. The cam shaft 172 can be rotationally pinned to the bevel gear 170, e.g., through a splined interface, an interference fit, a threaded or non-threaded fastener, an adhesive, or the like. The bevel gear 170 can transmit torque from the motor 114 (FIG. 1) to drive the cam shaft 172 to rotate about the rotational axis B.

The cam shaft 172 can include an elongated body 176 defining a first bearing interface 178, a first cam lobe 180, a second cam lobe 182, a bevel gear interface 184, and a second bearing interface 186. The first and second bearing interfaces 178 and 186 can be disposed on opposite ends of the elongated body 176 and each be supported by a bearing 188 and 190, respectively, to allow the cam shaft 172 to rotate about the rotational axis B. The first and second cam lobes 180 and 182 can be disposed between the bearings 188 and 190. In an embodiment, the first and second cam lobes 180 and 182 are disposed between the bevel gear interface 184 and the bearing 188. The first cam lobe 180 is shown disposed above the second cam lobe 182. The first cam lobe 180 can be referred to as an upper cam lobe and the second cam lobe 180 can be referred to as a lower cam lobe.

The first and second cam lobes 180 and 182 can be rotationally offset from one another about the central axis of the cam shaft 172, i.e., the rotational axis B. For example, the first and second cam lobes 180 and 182 can be rotationally offset from one another by at least 10°, such as at least 45°, such as at least 90°, such as at least 145°. In an embodiment, the first and second cam lobes 180 and 182 are rotationally offset from one another by 180°. Accordingly, a cam heel associated with the first cam lobe 180 can be in alignment with the second cam lobe 182, as seen along rotational axis B, and a cam heel associated with the second cam lobe 182 can be in alignment with the first cam lobe 180, as seen along rotational axis B.

FIG. 4 illustrates a top view of the work head 108 with the cover 136 removed, exposing the internal volume 134 of the work head 108. As depicted, the first and second cam lobes 180 and 182 are displaced from the rotational axis B in equal and opposite directions. Each of the first and second cam lobes 180 and 182 defines a generally arcuate outer perimeter 192. In the depicted embodiment, the outer perimeters 192 of both the first and second cam lobes 180 and 182 lie along circles.

Referring to FIGS. 3 and 4, the first cam lobe 180 interfaces with a first cam lobe receiving area 194 of a first link 196. As described below, the first link 196 can transmit motion from the first cam lobe 180 to the first blade 150 to reciprocate the first blade 150 about the rotational axis A (FIG. 2). The first cam lobe receiving area 194 can define a recess or opening in the first link 196 which can receive at least a portion of the first cam lobe 180. In an embodiment, the first cam lobe receiving area 194 is an opening extending through an entire thickness of the first link 196. The thickness of the first link 196 can be sized to match, or substantially match, a thickness of the first cam lobe 180, allowing opposite ends of the first cam lobe 180 to be coplanar with opposite ends of the first link 196. The first cam lobe receiving area 194 can define an elongated shape (e.g., FIG. 4) to accommodate rotation of the cam shaft 172 through 360° of rotation. In an embodiment, the first cam lobe receiving area 194 can define a width, as measured perpendicular to the rotational axis B, approximately equal to, or slightly larger than, a maximum dimension (e.g., diameter) of the first cam lobe 180. In an embodiment, the first cam lobe receiving area 194 can define a length, as measured perpendicular to the rotational axis B and the width of the first cam lobe receiving area 194, approximately equal to, or slightly larger than, two times the diameter of the first cam lobe 180 minus the diameter of the elongated body 176 at the location where the first cam lobe 180 projects from.

As the first cam lobe 180 is driven by the cam shaft 172 around the rotational axis B, the outer perimeter 192 of the first cam lobe 180 interfaces with a perimeter surface 198 of the first cam lobe receiving area 194, biasing the perimeter surface 198 of the first link 196 and causing the first link 196 to rotate around a rotational axis C. The perimeter surface 198 defines two drive surfaces 200 and 202 and two intermediary surfaces 204 and 206 disposed between the drive surfaces 200 and 202. The drive surfaces 200 and 202 are defined by portions of the perimeter surface 198 which, when biased by the first cam lobe 180, cause rotation of the first link 196 around the rotational axis C. Those portions of the perimeter surface 198 which do not cause the first link 196 to rotate around the rotational axis C when biased by the first cam lobe 180 are part of the intermediary surfaces 204 and 206.

In the embodiment depicted in FIG. 4, the perimeter surface 198 is a continuous (closed) surface. That is, the first link 196 includes a body defining the entire length of the perimeter surface 198 where the drive surfaces 200 and 202 and intermediary surfaces 204 and 206 form a continuous surface of the first link 196. In another embodiment, the perimeter surface 198 is a discontinuous (open) surface wherein at least a portion of one of the intermediary surfaces 204 or 206 is omitted.

The second cam lobe 182 can form a similar interface with a second cam lobe receiving area 208 of a second link 210. Referring to FIG. 3, the second link 210 can be oriented parallel with the first link 196. The second link 210 can be disposed adjacent to the first link 196 and rotate around rotational axis C as the second cam lobe 182 moves within the second cam lobe receiving area 208. While description of the interaction between the second cam lobe 182 and the second link 210 is omitted, it should be understood that the interface between second cam lobe 182, the second link 210, and the second cam lobe receiving area 208 can share any one or more same or similar characteristics as the interface between the first cam lobe 180, the first link 196, and the first cam lobe receiving area 194.

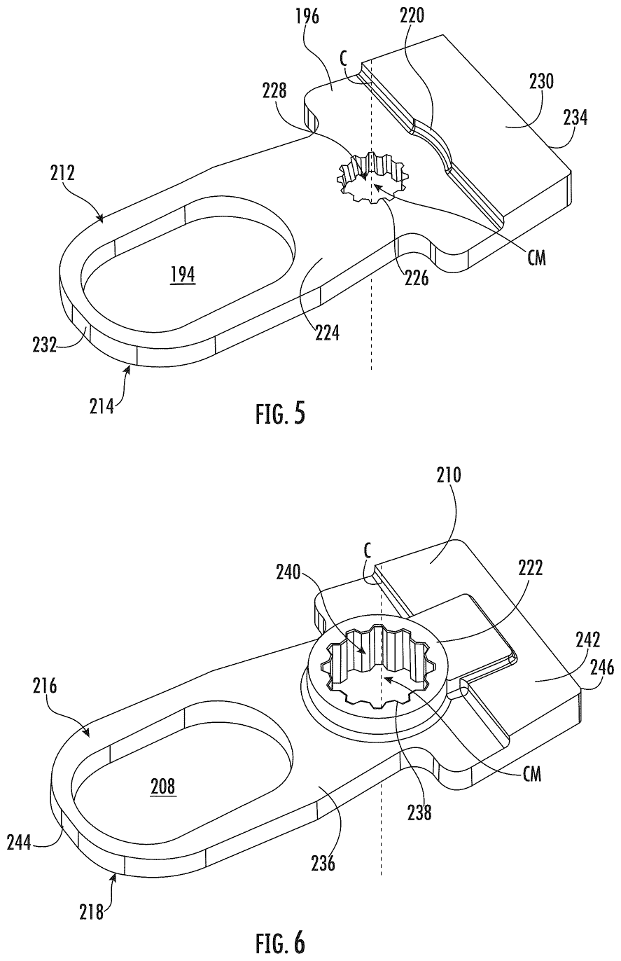

FIG. 5 illustrates the first link 196 in accordance with an exemplary embodiment. FIG. 6 illustrates the second link 210 in accordance with an exemplary embodiment. The first link 196 has a first side 212 and a second side 214 spaced apart from the first side 212 by a thickness of the first link 196. The second link 210 has a first side 216 and a second side 218 spaced apart from the first side 216 by a thickness of the second link 210. The first side 212 of the first link 196 can be disposed adjacent to the first side 216 of the second link 210. One or both of the first and second links 196 and 210 can include an accommodating feature to accommodate the other of the first and second links 196 and 210 while permitting the first and second links 196 and 210 to be disposed adjacent to one another. For instance, the accommodating feature can include a cutout lip 220 in the first link 196 to accommodate a projecting surface 222 of the second link 210.

In an embodiment, the first link 196 includes a body 224 defining the first cam lobe receiving area 194, an opening 226 that defines a first engagement interface 228, and a counterbalancing section 230. The first cam lobe receiving area 194 can be disposed at a first end 232 of the body 224 and the counterbalancing section 230 can be disposed at a second end 234 of the body 224. The first engagement interface 228 can be disposed between the first cam lobe receiving area 194 and the counterbalancing section 230. In an embodiment, the first engagement interface 228 is disposed closer to the second end 234 of the body 224 than the first end 232 of the body 224. However, a center of mass CM of the body 224 can be disposed at the first engagement interface 228. More particularly, the center of mass CM of the body 224 can be disposed at the rotational axis C around which the first link 196 moves.

In an embodiment, the second link 210 includes a body 236 defining the second cam lobe receiving area 208, an opening 238 that defines a second engagement interface 240, and a counterbalancing section 242. The second cam lobe receiving area 208 can be disposed at a first end 244 of the body 236 and the counterbalancing section 242 can be disposed at a second end 246 of the body 236. The second engagement interface 240 can be disposed between the second cam lobe receiving area 208 and the counterbalancing section 242. In an embodiment, the second engagement interface 240 is disposed closer to the second end 246 of the body 236 than the first end 244 of the body 236. However, a center of mass CM of the body 236 can be disposed at the second engagement interface 240. More particularly, the center of mass CM of the body 236 can be disposed at the rotational axis C around which the second link 210 moves.

Referring again to FIG. 3, the first link 196 can be coupled with a first shaft 248, sometimes referred to as an inner shaft, and the second link 210 can be coupled with a second shaft 250, sometimes referred to as an outer shaft. The first and second links 196 and 210 can be rotationally pinned with respect to the first and second shafts 248 and 250, respectively. That is, rotational movement of the first link 196, as created by movement of the first cam lobe 180 against the driving surfaces 200 and 202 (FIG. 4), causes an equal rotational movement of the first shaft 248. Thus, reciprocating movement of the first link 196 causes reciprocating movement of the first shaft 248. Similarly, rotational movement of the second link 210, as created by movement of the second cam lobe 182 against driving surfaces (not illustrated) of the second link 210, causes an equal rotational movement of the second shaft 250. Thus, reciprocating movement of the second link 210 causes reciprocating movement of the second shaft 250.

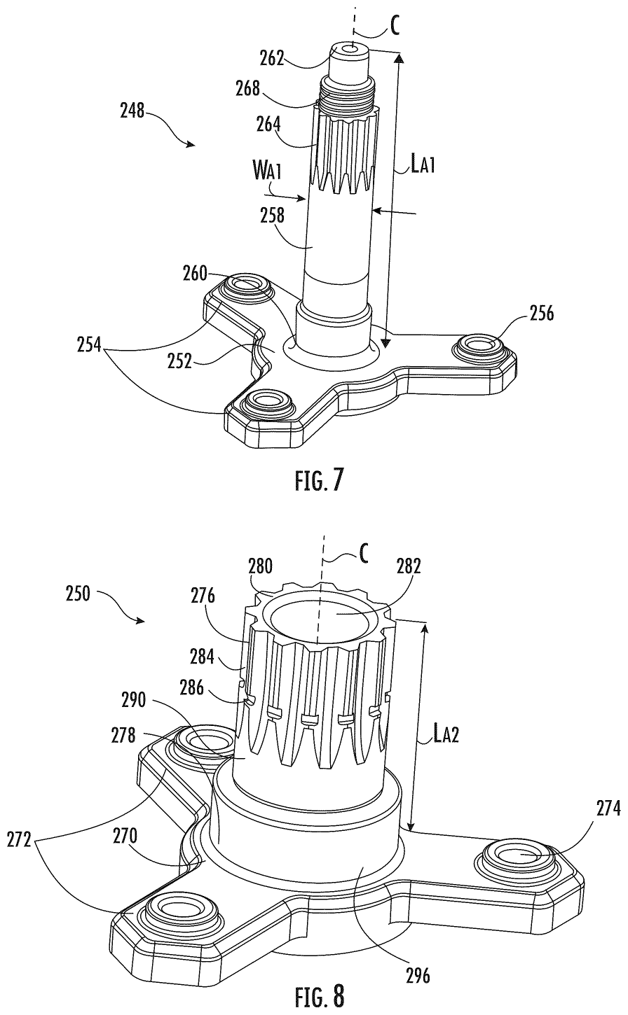

FIG. 7 illustrates the first (inner) shaft 248 in accordance with an exemplary embodiment. FIG. 8 illustrates the second (outer) shaft 250 in accordance with an exemplary embodiment. As described below, at least a portion of the first shaft 248 can be disposed within a portion of the second shaft 250. In an embodiment, the first shaft 248 extends through opposite ends of the second shaft 250. For example, a first portion of the first shaft 248 can extend from a first end of the second shaft 250 and be operably coupled to the first link 196 and a second portion of the first shaft 248 can extend from a second end of the second shaft 250 and be operably coupled to the first blade 150. The first and second shafts 250 and 252 can be coaxially positioned along the rotational axis C and free to rotate relative to one another about the rotational axis C. A bushing 251 can be disposed between the first and second shafts 250 and 252. The bushing 251 can facilitate a low friction interface between the first and second shafts 250 and 252 while further maintaining the first and second shafts 250 and 252 in coaxial alignment with one another.

Referring initially to FIG. 7, the first shaft 248 can generally include a hub 252 and a plurality of spokes 254 extending outward from the hub 252 in a radial direction. In an embodiment, the hub 252 and spokes 254 can lie along a same, or generally same, plane as one another, wherein the plane is oriented perpendicular to the rotational axis C. At least some of the spokes 254 define engagement features 256, such as openings, e.g., threaded openings, for coupling the first blade 150 to the first shaft 248 using fasteners 257 (FIG. 3). In the depicted embodiment, the first shaft 248 includes three spokes 254. In other embodiments, the first shaft 248 can include at least four spokes 254, such as at least five spokes 254, or even at least six spokes 254. The spokes 254 can be equally spaced apart from one another about the rotational axis C.

An axle 258 extends from the hub 252 in a direction along the rotational axis C. In an embodiment, the axle 258 is integral with the hub 252. In another embodiment, the axle 258 and hub 252 are discrete (separate) pieces temporarily or permanently joined together. The axle 258 defines a length L_{A1}, as measured between a first end 260 of the axle 258 and a second end 262 of the axle 258. The axle 258 further defines a width W_{A1}, as measured by a largest dimension of the axle 258 in a direction perpendicular to the length L_{A1}.

The axle 258 includes a first complementary engagement feature 264 configured to interface with the first engagement feature 228 of the first link 196 to rotationally pin the first link 196 and the first shaft 248 together. In an embodiment, the first engagement feature 228 and the first complementary engagement feature 264 define a splined interface. For instance, the first engagement feature 228 of the first link 196 (FIG. 5) can include a ridged or toothed profile that mates with a complementary ridged or toothed profile of the first complementary engagement feature 264 on the first shaft 248. To install the first link 196 and the first shaft 248 together, the axle 258 and first engagement feature 228 can be aligned and translated together along the rotational axis C until the first engagement feature 228 and the first complementary engagement feature 264 are mated with one another. A fastener 266 (FIG. 3) can then be installed on the first shaft 248 to retain the first link 196 on the first shaft 248. In an embodiment, the fastener 266 includes a nut (which can be referred to as an inner shaft nut) threadably receivable on a threaded interface 268 of the axle 258. The fastener 266 and interface 268 can alternatively include a bayonet interface, an interference fit, an adhesive interface, a pinned interface whereby a pin extends through aligned openings extending through the fastener 266 and the axle 258, a crimped fastener 266, a snap on retainer such as a snap on ring, or the like.

Referring to FIG. 8, the second shaft 250 can have a generally similar structure as compared to the first shaft 248. For example, the second shaft 250 can include a hub 270 and a plurality of spokes 272 extending outward from the hub 270 in a radial direction. In an embodiment, the hub 270 and spokes 272 can lie along a same, or generally same, plane as one another, wherein the plane is oriented perpendicular to the rotational axis C. At least some of the spokes 272 define engagement features 274, such as openings, e.g., threaded openings, for coupling the second blade 152 to the second shaft 250 using fasteners 275 (FIG. 3). In the depicted embodiment, the second shaft 250 includes threes spokes 272. In other embodiments, the second shaft 250 can include at least four spokes 272, such as at least five spokes 272, or even at least six spokes 272. The spokes 272 can be equally spaced apart from one another about the rotational axis C.

An axle 276 extends from the hub 270 in a direction along the rotational axis C. In an embodiment the axle 276 is integral with the hub 270. In another embodiment, the axle 276 and hub 270 are discrete (separate) pieces temporarily or permanently joined together. The axle 276 defines a length L_{A2}, as measured between a first end 278 of the axle 276 and a second end 280 of the axle 276. The axle 276 includes an aperture 282 extending between the first and second ends 278 and 280. The aperture 282 defines a width W_{A2}, as measured by a smallest dimension of the aperture 282 in a direction perpendicular to the length L_{A2}. The width W_{A2} of the aperture 282 is greater than the width W_{A1} of the axle 258 of the first shaft 248 such that the axle 258 fits within the aperture 282. In an embodiment, W_{A2} is at least 1.001 W_{A1}, such as at least 1.005 W_{A1}, such as at least 1.01 W_{A1}, such as 1.02 W_{A1}, such as 1.05 W_{A1}. Sufficient clearance between sidewalls of the aperture 282 and the axle 258 permit unrestricted relative rotation between the first and second shafts 248 and 250. The length L_{A1} of the axle 258 is greater than the length L_{A2} of the axle 276. In an embodiment, L_{A1} is at least 1.05 L_{A2}, such as at least 1.1 L_{A2}, such as at least 1.2 L_{A2}, such as at least 1.25 L_{A2}, such as at least 1.3 L_{A2}.

The axle 276 includes a second complementary engagement feature 284 configured to interface with the second engagement feature 240 of the second link 210 to rotationally pin the second link 210 and the second shaft 250 together. In an embodiment, the second engagement feature 228 and the second complementary engagement feature 284 define a splined interface. For instance, the second engagement feature 240 of the second link 210 (FIG. 6) can include a ridged or toothed profile that mates with a complementary ridged or toothed profile of the second complementary engagement feature 284 on the second shaft 250. To install the second link 210 and the second shaft 250 together, the axle 276 and the second shaft 250 can be aligned and translated together along the rotational axis C until the second engagement feature 228 and the second complementary engagement feature 284 are mated with one another.

Referring to FIGS. 3, 7 and 8, the first and second links 196 and 210 can be disposed adjacent to one another in a direction along the rotational axis C. In an embodiment, a low friction interface (not illustrated) can be disposed between the first and second links 196 and 210 to permit relative movement therebetween. The fastener 266 can prevent the first link 196 from moving in a first direction along the rotational axis C. Compressive force from the fastener 266 passes through the first link 196 to reach the second link 210 and prevent the second link 210 from moving in the first direction along the rotational axis C. In an embodiment, the second shaft 250 can include a structure 286, such as a notch extending around the circumference of the axle 276, that interfaces with a retaining element 288, such as a retaining clip, to prevent the second link 210 from moving in a second direction along the rotational axis C, the second direction being opposite to the first direction. As the fastener 266 is tightened along the threaded interface 268, the first and second links 196 and 210 can self-align relative to the first and second cam lobes 180 and 182. That is, the structure 286, retaining element 288, and threaded interface 268 can be arranged such that tightening the fastener 266 to a desired specification causes interfacing alignment between the first link 196 and the first cam lobe 180 and the second link 210 and the second cam lobe 182.

The axle 276 of the second shaft 250 can include a bearing surface 290 configured to interface with one or more bearings 292 to maintain the second shaft 250 along the rotational axis C. The bearing(s) 292 can include roller bearings, needle bearings, journal bearings, or the like. The bearings 292 can be retained by a retaining structure 294, such as a C-shaped span on ring. The axle 276 of the second shaft 250 can further include a sealing surface 296 configured to interface with a seal 298, such as a rotary seal, a lip seal, or the like. The seal 298 can extend between the sealing surface 296 and a sealing surface 300 of the housing 132 to prevent ingress of contaminant into the internal volume 134 of the housing 132. A seal 302 can be disposed between the first and second shafts 248 and 250 to further prevent ingress of contaminant into the internal volume 134.

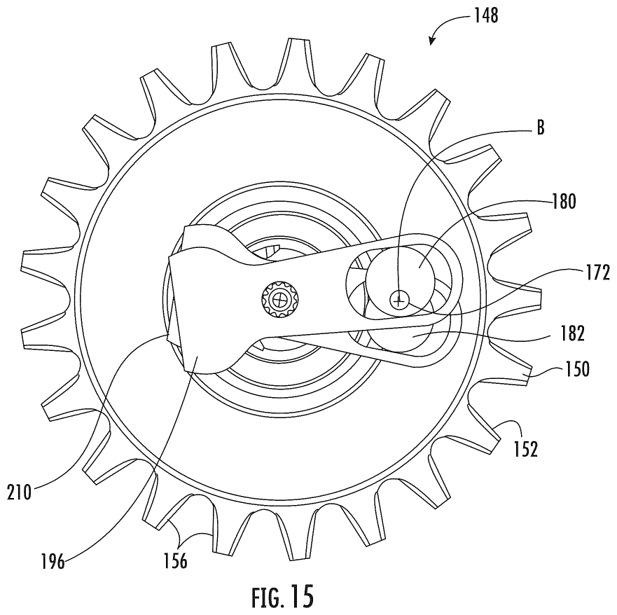

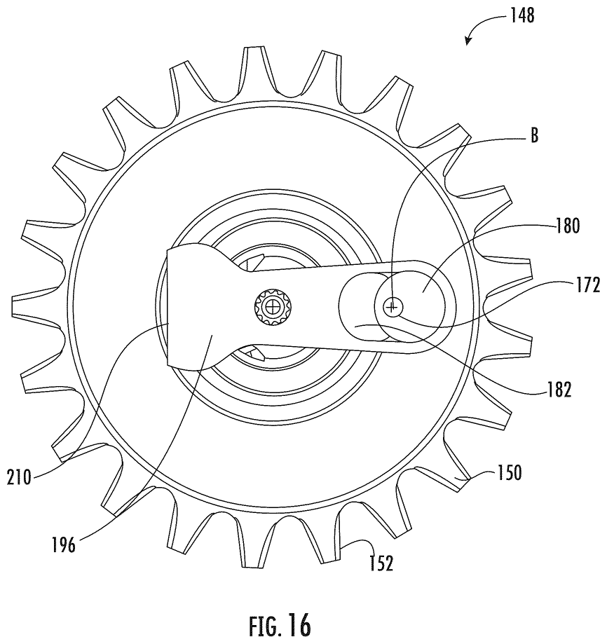

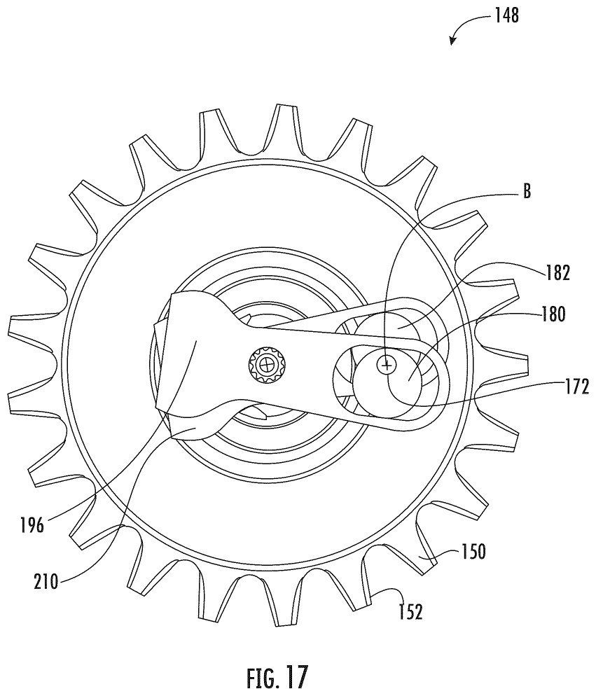

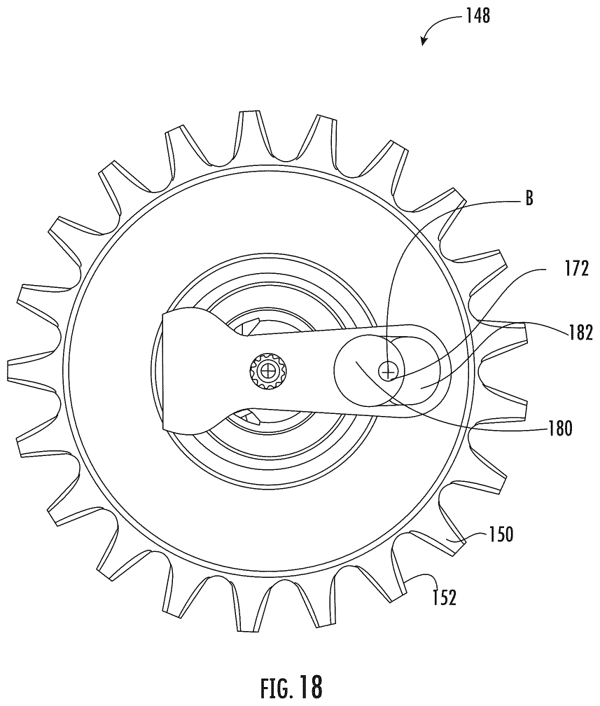

FIGS. 15 to 18 depict a top view of the camshaft 172 and the reciprocating blade set 148 undergoing reciprocation during use. In particular, FIG. 15 shows the reciprocating blade set 148 in a first position, FIG. 16 illustrates the reciprocating blade set 148 in a second position, FIG. 17 illustrates the reciprocating blade set 148 in a third position, and FIG. 18 illustrates the reciprocating blade set 148 in a fourth position. The reciprocating blade set 148 moves from the first position to the second position, from the second position to the third position, and from the third position to the fourth position. Once at the fourth position, the reciprocating blade set 148 moves to the first position and the cycle is repeated. Alternatively, the reciprocating blade set 148 can operate in a reverse direction moving from the fourth position to the third position, from the third position to the second position, and from the second position to the first position. The first and second cam lobes 180 and 182 rotate about the camshaft 172, e.g., rotational axis B, and drive the first and second links 196 and 210. The first and second links 196 and 210 are coupled to the first and second blades 150 and 152 of the reciprocating blade set 148, respectively, to drive the first and second blades 150 and 152 in opposite directions.

In accordance with an embodiment, and as shown in FIGS. 15 to 18, the teeth 156 of the first and second blades 150 and 152 can be arranged such that converging teeth 156 of the first and second blades 150 and 152 are rotationally overlapping each other at each of the first, second, third and fourth positions. In such a manner, the reciprocating blade set 148 can make four cuts during each cycle, e.g., between traveling from the first position back to the first position. In another embodiment, the teeth 156 of the first and second blades 150 and 152 can be rotationally offset from one another or spaced apart from one another in a manner such that converging teeth 156 of the first and second blades 150 and 152 do not overlap one another in at least one of the first, second, third or fourth positions (or at some point during movement therebetween). For instance, the converging teeth 156 can be rotationally staggered from one another in the first and third positions (FIGS. 15 and 17) and rotationally overlap each other in the second and fourth positions (FIGS. 16 and 18). Alternatively, the converging teeth 156 can be rotationally overlapping in the second and fourth positions (FIGS. 16 and 18) and rotationally staggered from one another in the first and third positions (FIGS. 15 and 17). In such a manner, the reciprocating blade set 148 can make less than four cuts, e.g., two cuts, during each cycle, e.g., between traveling from the first position back to the first position.

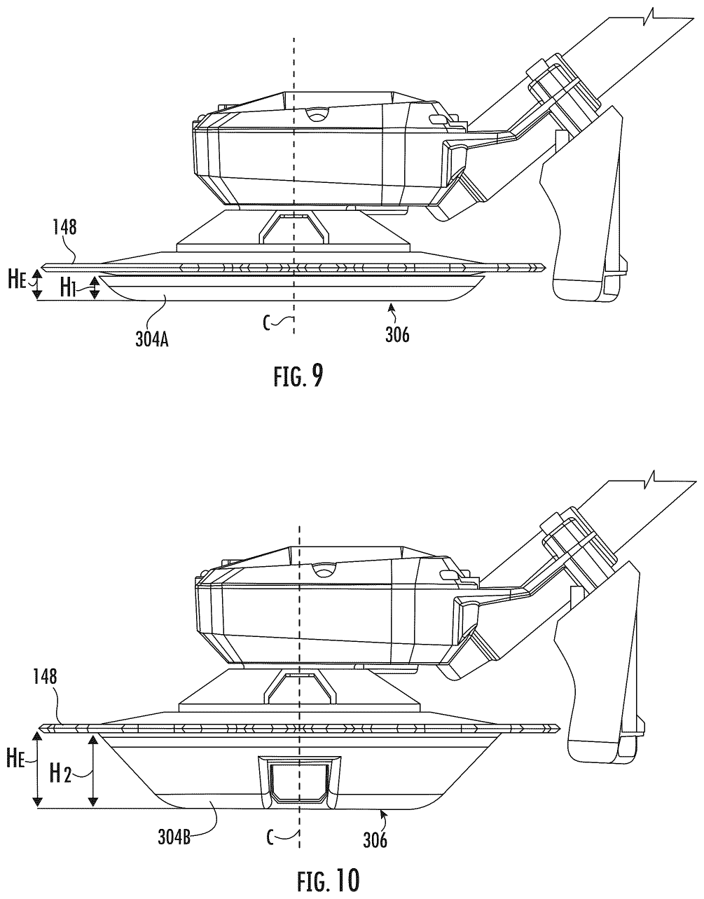

Referring to FIGS. 2, 9, and 10, the reciprocating power tool 100 can further include a skid plate 304. The skid plate 304 can be removably coupled with the work head 108. The skid plate 304 can be selected from a plurality of skid plates 304 each having a different characteristic. For example, FIG. 9 illustrates a first skid plate 304A and FIG. 10 illustrates a second skid plate 304B. The first and second skid plates 304A and 304B can each define a height H₁ and H₂, respectively. The heights H₁ and H₂ can be measured in a direction along the rotational axis C of the blades 150 and 152. The heights H₁ and H₂ are different from one another. For instance, by way of non-limiting example, H₁ can be 1″ and H₂ can be 3″. Other heights can include 1.5″, 2″, 2.5″, 3.5″, 4″, 4.5″, 5″, etc. A user can switch between the different skid plates 304 to change an effective cutting height HE of the reciprocating blade set 148 relative to a bottom surface 306 of the skid plate 304. The user can swap from the first skid plate 304A to the second skid plate 304B to increase the effective cutting height HE. Conversely, the user can swap from the second skid plate 304B to the first skid plate 304A to decrease the effective cutting height HE.

FIG. 3 illustrates an exemplary embodiment of the work head 108 without the skid plate 304 coupled therewith. As depicted, the first shaft 248 defines a recess 308. The recess 308 includes a skid plate engagement point 310 including a threadable interface that threadably receives a complementary skid plate engagement point 312, such as a skid plate retaining bolt 313. The skid plate 304 can include a central opening (not illustrated) through which the skid plate retaining bolt 313 extend through. After aligning the skid plate 304 and the skid plate retaining bolt 313 with the recess 308, the user can tighten the skid plate retaining bolt 313 with the threadable interface to secure the skid plate 304 relative to the reciprocating power tool 100. To swap skid plates 304, the user removes the skid plate retaining bolt and current skid plate 304, and repeats the above described steps with a different skid plate 304 to secure the different skid plate relative to the reciprocating power tool 100.

FIG. 11 illustrates a cross-sectional perspective view of the work head 108 as seen along Line B-B in FIG. 2 with the skid plate 304 coupled to the reciprocating power tool 100 in accordance with another exemplary embodiment. As depicted, the reciprocating blade set 148 comprises a first snap on feature 314 forming the complementary skid plate engagement point. The first snap on feature 314 can be part of the second blade 152 and can define an opening or recess extending into the second blade 152. The skid plate 304 can include a second snap on feature 316 configured to removably interface with the first snap on feature 314 to selectively couple the skid plate 304 to the work head 108. For example, the second snap on feature 316 can include a flange 318 extending from a main body portion 320 of the skid plate 304. The flange 318 can be radially deflectable relatively to the rotational axis C and include a head portion 322 that interfaces with the first snap on feature 314. By deflecting the flange 318, the head portion 322 can translate in a direction along the rotational axis C into the opening or recess of the first snap on feature 314. Once the head portion 322 is aligned with the first snap on feature 314, the flange 318 returns to its unbiased state to interface with the opening or recess to selectively couple the skid plate 304 to the work head 108. The user can release the skid plate 304 from the work head 108 by again deflecting the flange 318 such that the head portion 322 can pass from the opening or recess, allowing the skid plate 304 to be translated away from the work head 108 in a direction along the rotational axis C.

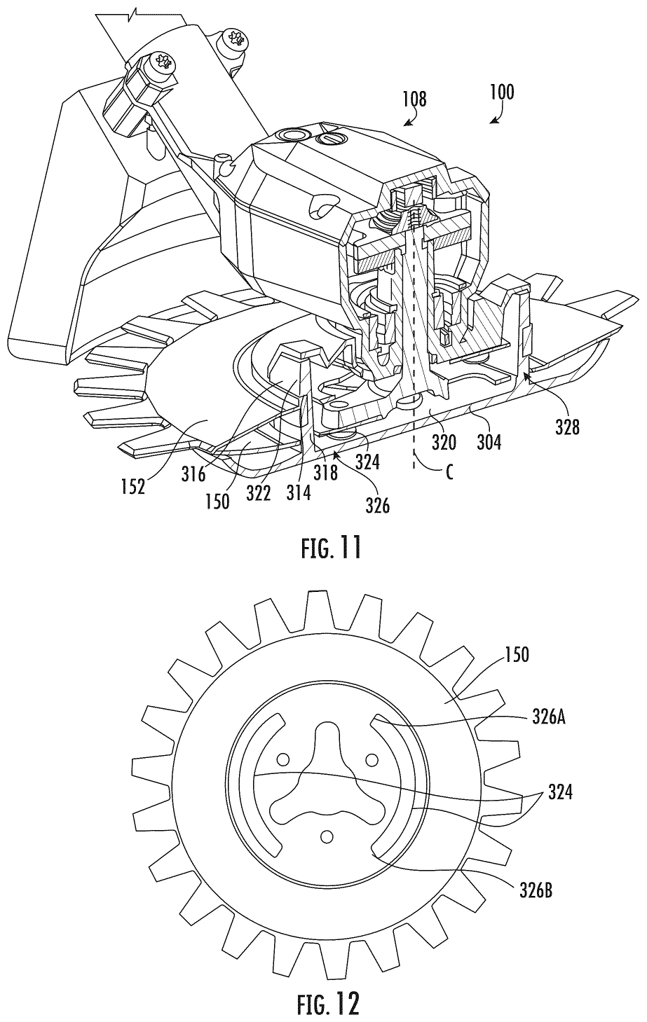

Referring to FIGS. 11 and 12, the first blade 150 can include one or more apertures 324 through which the second snap on feature 316, e.g., the flange 318 and head portion 322, can extend through when the skid plate 314 is coupled to the work head 108. The aperture(s) 324 can be sized larger than the second snap on feature 316 in the circumferential direction to permit reciprocation between the first and second blades 150 and 152 without the second snap on feature 316 bumping into circumferential ends 326A and 326B of the aperture 324.

The first and second snap on features 314 and 316 described above can be referred to as a snap on interface 326. In an embodiment, the skid plate 304 can be coupled with the work head 108 through a plurality of snap on interfaces, such as the aforementioned snap on interface 326 and one or more additional snap on interfaces, such as a second snap on interface 328. The snap on interfaces can be equally spaced apart around the rotational axis C.

FIG. 13 illustrates an exemplary embodiment of the reciprocating power tool 100 being used as an edger 330. The edger 330 includes a reciprocating blade set 332 having the same, or similar, characteristics as the reciprocating blade set 148 described above. Instead of a continuously rotating cutting implement that rotates around a central point over 360°, the reciprocating blade set 332 can operate within a banded rotational range. Cutting teeth 338 disposed along the circumference of the first and second blades 334 and 336 repeatedly converge to cut material disposed within effective gaps of the first and second blades 334 and 336. A guide wheel 340 can support the reciprocating blade set 332 and allow a user to push the edger 330 over an underlying ground surface. A guard 342 can cover at least a portion of the reciprocating blade set 332 to prevent flying debris from hitting the user.

In an embodiment, the edger 330 can be formed by rotating the work head 108 of the reciprocating power tool 100, e.g., using the adjustment element 130 depicted in FIG. 1. The guard 342 and guide wheel 340 can be coupled to the work head 108, or another portion of the reciprocating power tool 100, to provide functional structure for edging operations.

Reciprocating power tools 100 described herein can provide enhanced user experience. For example, reciprocating power tools 100 described herein can transmit less vibration and wobble to the user as compared to traditional reciprocating power tools. Power tools often generate vibrational frequencies as a result of engine vibration, shaft and rotational imbalances, imbalances in center of mass, imbalances in center of gravity heights, imbalances in moments of inertia, etc. Each one of these imbalances creates harmonic resonance which, when combined together, transmit vibration of the user holding the power tool. Prolonged exposure to such vibrational forces can cause excessive user fatigue, resulting in premature termination of a work activity. Reciprocating power tools 100 described herein alleviate user fatigue and allow for a longer, more enjoyable working experience.

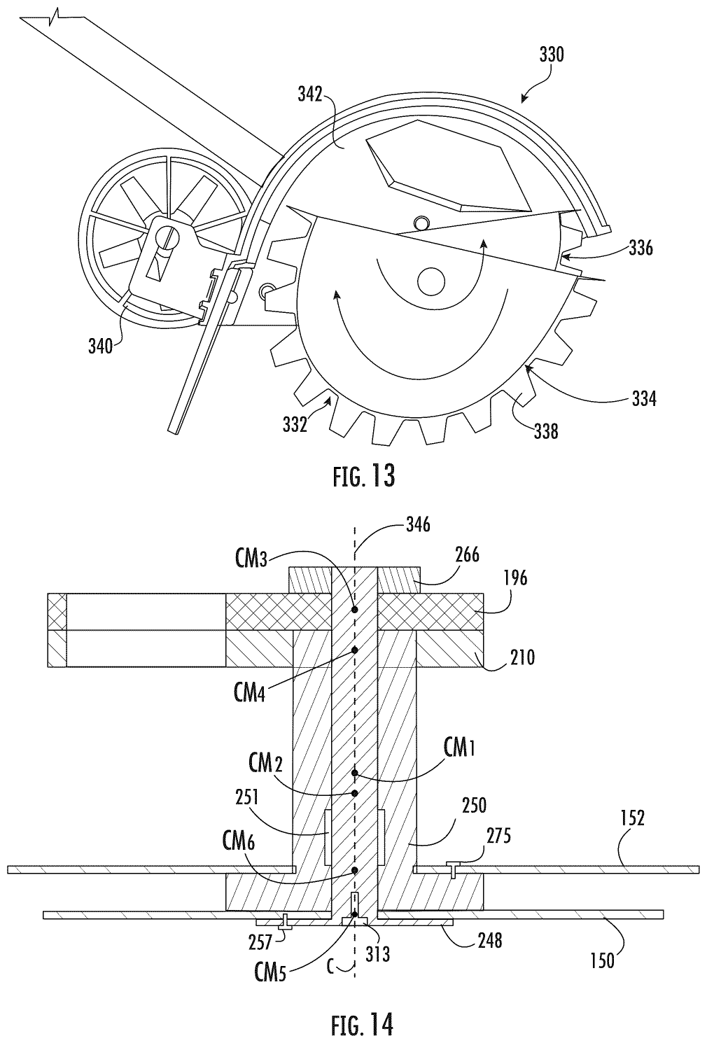

FIG. 14 illustrates a schematic, cross-sectional view of the inner (first) shaft assembly and the outer (second) shaft assembly in accordance with an embodiment. The inner shaft assembly generally includes the first link 196, the first shaft 248, and the first blade 150. The outer shaft assembly generally includes the second link 210, the second shaft 250, and the second blade 152. In an embodiment, the inner shaft assembly further includes the skid plate retaining bolt 313, the fasteners 257, the inner shaft nut 266, and a blade cap. The outer shaft assembly further includes the bushing 251 and the fasteners 275.

Tables 1 and 2 show characteristics of the components of the inner and outer shaft assemblies.

TABLE 1
Inner Shaft Assembly

| | | | | | | | Height of |
|---|---|---|---|---|---|---|---|
| | | | Material | | C.G. Distance from | Moment of Inertia about | C.G. of the |
| | Volume | | Density | Mass | Rotational Axis C | Rotational Axis C | system |
| Component | (mm³) | Quantity | (g/mm³) | (g) | (mm) | (kg*mm²) | (mm) |
| Inner Shaft | 16,041 | 1 | 0.008 | 128.328 | −55.9 | 36 | −56.37 |
| Skid Plate | 2529 | 1 | 0.008 | 20.232 | −63.8 | 0.35 | |
| Retaining Bolt | | | | | | | |
| First Blade | 31626 | 1 | 0.008 | 253.008 | −70.15 | 1483 | |
| Fasteners | 544 | 3 | 0.008 | 13.056 | −63 | 4 | |
| Blade Cap | 6116 | 1 | 0.008 | 48.928 | −78.23 | 48.92 | |
| First Link | 12035 | 1 | 0.008 | 96.28 | −17.46 | 55.6 | |
| Inner Shaft Nut | 2688 | 1 | 0.008 | 21.504 | −10.6 | 1.8 | |

| | | |
|---|---|---|
| TOTAL | 581.3 | 1630 |

TABLE 2
Outer Shaft Assembly

| | | | Material | | C.G. Distance from | Moment of Inertia about | Height of C.G. |
|---|---|---|---|---|---|---|---|
| | Volume | | Density | Mass | Rotational Axis C | Rotational Axis C | of the system |
| Component | (mm³) | Quantity | (g/mm³) | (g) | (mm) | (kg*mm²) | (mm) |
| Outer Shaft | 25286 | 1 | 0.008 | 202.288 | −53.2 | 106.6 | −56.42 |
| Bushing | 893 | 1 | 0.008 | 5.7152 | −52.24 | 0.43 | |
| Second Blade | 31575 | 1 | 0.008 | 252.6 | −70.15 | 1483.8 | |
| Fasteners | 544 | 3 | 0.008 | 13.056 | −74.96 | 4 | |
| Second Link | 11240 | 1 | 0.008 | 89.92 | −22.68 | 55.2 | |

| | | |
|---|---|---|
| TOTAL | 563.6 | 1650 |

Referring to Table 1, the inner shaft assembly has a mass of 581.3 g and a moment of inertia about rotational axis C of 1630 kg*mm². The inner shaft assembly has a height of center of gravity of the system of −56.37 mm. The height of center of gravity is measured with respect to a plane oriented perpendicular to the rotational axis C and is represented in FIG. 3 by line 344. Negative values for the height of the center of gravity are representative of distances below the line 344, i.e., towards the reciprocal blade set 148, while positive values are representative of distance above the line 344. The line 344 can be selected at any elevation along the rotational axis C.

Referring to Table 2, the outer shaft assembly has a mass of 563.6 g and a moment of inertia about rotational axis C of 1650 kg*mm². The outer shaft assembly has a height of center of gravity of the system of −56.42 mm.

Table 3 below shows a comparison of the inner and outer shaft assemblies.

TABLE 3
Comparison between inner and outer shaft assemblies

| | Total | Moment of Inertia | Height of |
|---|---|---|---|
| | Mass | about Rotational | C.G of the |
| | (g) | Axis C (kg*mm²) | system (mm) |
| Inner Shaft Assembly | 581.3 | 1630 | −56.37 |
| Outer Shaft Assembly | 563.6 | 1650 | −56.42 |
| Difference | 17.8 | 20.36 | 0.05 |
| Percent Difference | 3.1% | 1.25% | 0.09% |

In an embodiment, the inner and outer shaft assemblies can differ in mass by less than 10%, such as by less than 8%, such as by less than 6%, such as by less than 5%, such as by less than 4%. As shown in Table 3, the inner and outer shaft assemblies differ in mass by 17.8 grams, or 3.1%. The inner and outer shaft assemblies can differ in moments of inertia about the rotational axis C by less than 10%, such as by less than 8%, such as by less than 6%, such as by less than 5%, such as by less than 4%, such as by less than 2%. The inner and outer shaft assemblies differ in their moments of inertia about the rotational axis C by 20.36 kg*mm², or 1.25%. As shown in Table 3, the inner and outer shaft assemblies can differ in their heights of center of gravity by less than 5%, such as by less than 4%, such as by less than 3%, such as by less than 2%, such as by less than 1%, such as by less than 0.5%, such as by less than 0.25%, such as by less than 0.2%. As shown in Table 3, the inner and outer shaft assemblies differ in their heights of center of gravity by 0.05 mm, or 0.09%.

Balancing mass, moment of inertia, and height of center of gravity reduces vibrational characteristics generated in the work head 108 (FIG. 2) during high speed reciprocation of the first and second blades 150 and 152, thereby reducing the transfer of vibrational frequencies to the user holding the first and second handles 102 and 104 (FIG. 1). The user can therefore continue to use the reciprocating power tool for extended periods of time without incurring significant fatigue or physical stress.

As depicted in FIG. 14, each one of the first shaft 148, the second shaft 150, the first link 196, the second link 210, the first blade 150, and the second blade 152 defines a center of mass CM. The first shaft 148 defines a first center of mass CM1. The second shaft 150 defines a second center of mass CM2. The first link 196 defines a third center of mass CM3. The second link 210 defines a fourth center of mass CM4. The first blade 150 defines a fifth center of mass CM5. The second blade 152 defines a sixth center of mass CM6. In an embodiment, the centers of mass CM₁₋₆ of each of the first shaft 148, the second shaft 150, the first link 196, the second link 210, the first blade 150, and the second blade 152 are aligned to within ±2 centimeters (cm) of a center of mass axis 346 representing a best fit line of the centers of mass CM of the first shaft 148, the second shaft 150, the first link 196, the second link 210, the first blade 150, and the second blade 152. That is, the centers of mass CM₁₋₆ of the first shaft 148, the second shaft 150, the first link 196, the second link 210, the first blade 150, and the second blade 152 can all be within ±2 cm of a straight line 346. In another embodiment, the centers of mass CM₁₋₆ of each of the first shaft 148, the second shaft 150, the first link 196, the second link 210, the first blade 150, and the second blade 152 are aligned to within ±1.5 cm of the center of mass axis 346, such as within ±1 cm of the center of mass axis 346, such as within ±0.75 cm of the center of mass axis 346, such as within ±0.5 cm of the center of mass axis 346, such as within ±0.25 cm of the center of mass axis 346, such as within ±0.1 cm of the center of mass axis 346, such as within ±0.05 cm of the center of mass axis 346, such as within ±0.01 cm of the center of mass axis 346. In a particular embodiment, the centers of mass CM₁₋₆ of each of the first shaft 148, the second shaft 150, the first link 196, the second link 210, the first blade 150, and the second blade 152 are all disposed on the center of mass axis 346.

The center of mass axis 346 is oriented parallel with the rotational axis C. In an embodiment, the center of mass axis 344 is coaxial with the rotational axis C. As such, the effective centers of mass CM of the inner and outer shaft assemblies can be balanced along the rotational axis C despite the first and second links 196 and 210 being cantilevered relative to the rotational axis C.

To further reduce vibrational transfer to the user, the rotational axis B of the cam shaft 172 is parallel to the rotational axis C. Due to the proximity of the first and second cam lobes 180 and 182 and their relatively same size and shape as one another, the effects of imbalance exhibited by the cam shaft 172 during rotation is negligible on system performance and experience.

Further aspects of the invention are provided by one or more of the following embodiments:

Embodiment 1. A reciprocating power tool comprising: a cam shaft rotatably driven by a motor, wherein the cam shaft comprises a first cam lobe and a second cam lobe, wherein the cam shaft defines a central axis, and wherein the first cam lobe and the second cam lobe are rotationally offset from one another about the central axis of the cam shaft; an inner shaft assembly comprising: a first link operably coupled to the first cam lobe, wherein the first link comprises a first engagement interface; a first shaft coupled to the first engagement interface and reciprocatively driven by the first link; and a first blade having an outer circumference defined by a first plurality of cutting teeth, wherein the first blade is coupled to the first shaft; and an outer shaft assembly comprising: a second link operably coupled to the second cam lobe, wherein the second link comprises a second engagement interface; a second shaft coupled to the second engagement interface and reciprocally driven by the second link; and a second blade having an outer circumference defined by a second plurality of cutting teeth, wherein the second blade is coupled to the second shaft, wherein the first link, the second link, the first shaft, and the second shaft each define a center of mass, and wherein the centers of mass of the first link, the second link, the first shaft, and the second shaft all lie within 1 centimeter (cm) of a center of mass axis.

Embodiment 2. The reciprocating power tool of embodiment 1, wherein the first and second blades each define a center of mass, and wherein the centers of mass of the first and second blades lie along the center of mass axis.

Embodiment 3. The reciprocating power tool of any one of embodiments 1 or 2, wherein: the inner shaft assembly further comprises: a skid plate bolt configured to releasably couple a skid plate to the first shaft; one or more fasteners coupling the first blade to the first shaft; and an inner shaft nut coupled to the first shaft to maintain the first link interfaced with the first shaft, and the outer shaft assembly further comprises: a bearing; and one or more fasteners coupling the second blade to the second shaft.

Embodiment 4. The reciprocating power tool of embodiment 3, wherein the inner shaft assembly defines a first moment of inertia, wherein the outer shaft assembly defines a second moment of inertia, and wherein the first and second moments of inertia are within 5% of one another.

Embodiment 5. The reciprocating power tool of any one of embodiments 3 or 4, wherein the inner shaft assembly defines a first height associated with a center of gravity of the inner shaft assembly, wherein the outer shaft assembly defines a second height associated with a center of gravity of the outer shaft assembly, wherein the first and second heights are measured from a reference plane oriented perpendicular to a rotational axis of the inner and outer shaft assemblies, and wherein the first and second heights are within 2% of one another.

Embodiment 6. The reciprocating power tool of any one of embodiments 3, 4 or 5, wherein the inner shaft assembly defines a first total mass, wherein the outer shaft assembly defines a second total mass, and wherein the first and second total masses are within 5% of one another.

Embodiment 7. The reciprocating power tool of any one of the preceding embodiments, further comprising a drive shaft having a distal end driven by the motor and a proximal end comprising a bevel pinion that drives a bevel gear of the cam shaft to rotate the cam shaft.

Embodiment 8. The reciprocating power tool of any one of the preceding embodiments, wherein the cam shaft is oriented parallel with the center of mass axis.

Embodiment 9. The reciprocating power tool of any one of the preceding embodiments, wherein the first link comprises a body defining a first cam lobe receiving area that receives the first cam lobe, an opening defining the first engagement interface, and a counterbalancing section, wherein the first engagement interface is disposed between the first cam lobe receiving area and the counterbalancing section, and wherein a center of mass of the body is disposed at the first engagement interface.

Embodiment 10. The reciprocating power tool of any one of the preceding embodiments, wherein the second link comprises a body defining a second cam lobe receiving area that receives the second cam lobe, an opening defining the second engagement interface, and a counterbalancing section, wherein the second engagement interface is disposed between the second cam lobe receiving area and the counterbalancing section, and wherein a center of mass of the body is disposed at the second engagement interface.

Embodiment 11. The reciprocating power tool of any one of embodiments 1 or 2, further comprising a skid plate bolt configured to releasably couple a skid plate to the inner shaft assembly, wherein the skid plate is selectable from a plurality of skid plates each defining a different guide height.

Embodiment 12. The reciprocating power tool of any one of embodiments 1 or 2, wherein the work head comprises one or more skid plate engagement points, wherein the reciprocating power tool further comprises a skid plate having a one or more complementary skid plate engagement points configured to be releasably coupled with the one or more skid plate engagement points.

Embodiment 13. The reciprocating power tool of embodiment 12, wherein the one or more skid plate engagement points each comprise a first snap on feature disposed at the second blade, wherein the one or more complementary skid plate engagement points each comprise a second snap on feature, and wherein each of the first and second snap on features are configured to be removably coupled together to retain the skid plate at the work head.

Embodiment 14. The reciprocating power tool of any one of embodiments 12 or 13, wherein the first blade comprises one or more aperture through which the one or more complementary skid plate engagement points extend when the skid plate is coupled to the second blade.

Embodiment 15. A reciprocating power tool comprising a first blade and a second blade, wherein the first blade is driven by a first shaft assembly, wherein the second blade is driven by a second shaft assembly, wherein the first and second blade assemblies are reciprocally driven by a cam shaft, wherein the first shaft assembly defines a first moment of inertia, wherein the second shaft assembly defines a second moment of inertia, and wherein the first and second moments of inertia are within 5% of one another.

Embodiment 16. The reciprocating power tool of embodiment 15, wherein the first shaft assembly defines a first height associated with a center of gravity of the first shaft assembly, wherein the second shaft assembly defines a second height associated with a center of gravity of the second shaft assembly, wherein the first and second heights are measured from a reference plane oriented perpendicular to a rotational axis of the first and second shaft assemblies, and wherein the first and second heights are within 2% of one another.

Embodiment 17. The reciprocating power tool of any one of embodiments 15 or 16, wherein the first shaft assembly defines a first total mass, wherein the second shaft assembly defines a second total mass, and wherein the first and second total masses are within 5% of one another.

Embodiment 18. The reciprocating power tool of any one of embodiments 15, 16 or 17, further comprising a skid plate releasably coupled to one of the first or second shaft assemblies, wherein the skid plate is selected form a plurality of skid plates each defining a different guide height.

Embodiment 19. A reciprocating power tool comprising: a first blade; a second blade coaxially aligned with the first blade; and a skid plate releasably coupled to one of the first or second blades, wherein the skid plate is selected from a plurality of skid plates each defining a different height.

Embodiment 20. The reciprocating power tool of embodiment 19, wherein the first blade is disposed between the second blade and the skid plate, and wherein a portion of the skid plate extends through the first plate to releasably couple with the second plate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A reciprocating power tool comprising:
a cam shaft rotatably driven by a motor, wherein the cam shaft comprises a first cam lobe and a second cam lobe, wherein the cam shaft defines a central axis, and wherein the first cam lobe and the second cam lobe are rotationally offset from one another about the central axis of the cam shaft;
an inner shaft assembly comprising:
a first link operably coupled to the first cam lobe, wherein the first link comprises a first engagement interface;
a first shaft coupled to the first engagement interface and reciprocatively driven by the first link; and
a first blade having an outer circumference defined by a first plurality of cutting teeth, wherein the first blade is coupled to the first shaft; and
an outer shaft assembly comprising:
a second link operably coupled to the second cam lobe, wherein the second link comprises a second engagement interface;
a second shaft coupled to the second engagement interface and reciprocally driven by the second link; and
a second blade having an outer circumference defined by a second plurality of cutting teeth, wherein the second blade is coupled to the second shaft,
wherein the first link, the second link, the first shaft, and the second shaft each define a center of mass, and wherein the centers of mass of the first link, the second link, the first shaft, and the second shaft all lie within 1 centimeter (cm) of a center of mass axis.

2. The reciprocating power tool of claim 1, wherein the first and second blades each define a center of mass, and wherein the centers of mass of the first and second blades lie along the center of mass axis.

3. The reciprocating power tool of claim 1, wherein:
the inner shaft assembly further comprises:
a skid plate bolt configured to releasably couple a skid plate to the first shaft;
one or more fasteners coupling the first blade to the first shaft; and
an inner shaft nut coupled to the first shaft to maintain the first link interfaced with the first shaft, and
the outer shaft assembly further comprises:
a bearing; and
one or more fasteners coupling the second blade to the second shaft.

4. The reciprocating power tool of claim 3, wherein the inner shaft assembly defines a first moment of inertia, wherein the outer shaft assembly defines a second moment of inertia, and wherein the first and second moments of inertia are within 5% of one another.

5. The reciprocating power tool of claim 4, wherein the inner shaft assembly defines a first height associated with a center of gravity of the inner shaft assembly, wherein the outer shaft assembly defines a second height associated with a center of gravity of the outer shaft assembly, wherein the first and second heights are measured from a reference plane oriented perpendicular to a rotational axis of the inner and outer shaft assemblies, and wherein the first and second heights are within 2% of one another.

6. The reciprocating power tool of claim 3, wherein the inner shaft assembly defines a first total mass, wherein the outer shaft assembly defines a second total mass, and wherein the first and second total masses are within 5% of one another.

7. The reciprocating power tool of claim 1, further comprising a drive shaft having a distal end driven by the motor and a proximal end comprising a bevel pinion that drives a bevel gear of the cam shaft to rotate the cam shaft.

8. The reciprocating power tool of claim 1, wherein the cam shaft is oriented parallel with the center of mass axis.

9. The reciprocating power tool of claim 1, wherein the first link comprises a body defining a first cam lobe receiving area that receives the first cam lobe, an opening defining the first engagement interface, and a counterbalancing section, wherein the first engagement interface is disposed between the first cam lobe receiving area and the counterbalancing section, and wherein a center of mass of the body is disposed at the first engagement interface.

10. The reciprocating power tool of claim 1, wherein the second link comprises a body defining a second cam lobe receiving area that receives the second cam lobe, an opening defining the second engagement interface, and a counterbalancing section, wherein the second engagement interface is disposed between the second cam lobe receiving area and the counterbalancing section, and wherein a center of mass of the body is disposed at the second engagement interface.

11. The reciprocating power tool of claim 1, further comprising a skid plate bolt configured to releasably couple a skid plate to the inner shaft assembly, wherein the skid plate is selectable from a plurality of skid plates each defining a different guide height.

12. The reciprocating power tool of claim 1, wherein the work head comprises one or more skid plate engagement points, wherein the reciprocating power tool further comprises a skid plate having a one or more complementary skid plate engagement points configured to be releasably coupled with the one or more skid plate engagement points.

13. The reciprocating power tool of claim 12, wherein the one or more skid plate engagement points each comprise a first snap on feature disposed at the second blade, wherein the one or more complementary skid plate engagement points each comprise a second snap on feature, and wherein each of the first and second snap on features are configured to be removably coupled together to retain the skid plate at the work head.

14. The reciprocating power tool of claim 13, wherein the first blade comprises one or more aperture through which the one or more complementary skid plate engagement points extend when the skid plate is coupled to the second blade.

15. A reciprocating power tool comprising a first blade and a second blade, wherein the first blade is driven by a first shaft assembly, wherein the second blade is driven by a second shaft assembly, wherein the first and second blade assemblies are reciprocally driven by a cam shaft, wherein the first shaft assembly defines a first moment of inertia, wherein the second shaft assembly defines a second moment of inertia, and wherein the first and second moments of inertia are within 5% of one another.

16. The reciprocating power tool of claim 15, wherein the first shaft assembly defines a first height associated with a center of gravity of the first shaft assembly, wherein the second shaft assembly defines a second height associated with a center of gravity of the second shaft assembly, wherein the first and second heights are measured from a reference plane oriented perpendicular to a rotational axis of the first and second shaft assemblies, and wherein the first and second heights are within 2% of one another.

17. The reciprocating power tool of claim 15, wherein the first shaft assembly defines a first total mass, wherein the second shaft assembly defines a second total mass, and wherein the first and second total masses are within 5% of one another.

18. The reciprocating power tool of claim 15, further comprising a skid plate releasably coupled to one of the first or second shaft assemblies, wherein the skid plate is selected form a plurality of skid plates each defining a different guide height.

19. A reciprocating power tool comprising:
a first blade;
a second blade coaxially aligned with the first blade; and
a skid plate releasably coupled to one of the first or second blades, wherein the skid plate is selected from a plurality of skid plates each defining a different height.

20. The reciprocating power tool of claim 19, wherein the first blade is disposed between the second blade and the skid plate, and wherein a portion of the skid plate extends through the first plate to releasably couple with the second plate.
